(19) United States
(12) Patent Application Publication
(10) Pub. No.: US 2026/0320730 A1
(43) Pub. Date: Oct. 15, 2026

(54) METHOD AND APPARATUS FOR OPTIMIZING ANDROID CONTAINER DISPLAY SYSTEM, ELECTRONIC DEVICE, COMPUTER-READABLE STORAGE MEDIUM AND COMPUTER PROGRAM PRODUCT

(71) Applicant: MOORE THREADS TECHNOLOGY CO., LTD., Beijing (CN)

(72) Inventors: Junchao NI, Beijing (CN); Riliang PENG, Beijing (CN)

(21) Appl. No.: 19/483,739

(22) PCT Filed: May 7, 2024
(86) PCT No.: PCT/CN2024/091410

§ 371 Date: Nov. 12, 2025

(30) Foreign Application Priority Data
May 15, 2023 (CN) 202310544843.7

(51) Int. Cl. G06T 1/20

(52) U.S. Cl. CPC G06T 1/20

(57) ABSTRACT

The present application relates to the technical field of computers, and provides a method and apparatus for optimizing an Android container display system, an electronic device, a computer-readable storage medium and a computer program product. The method for optimizing the Android container display system comprises: a HWC program generating a vsync signal, the vsync signal comprising an app-vsync signal; a target application program sending a rendering instruction in response to the app-vsync signal, the rendering instruction being used to instruct performing graphic rendering on a surface in the target application program using hardware rendering means; in response to the rendering instruction, a GPU hardware driving layer calling a hardware GPU connected to the Android container display system to perform graphic rendering, to obtain initial surface rendering data; and a Surfaceflinger module outputting target surface rendering data according to the initial surface rendering data.

### CROSS-REFERENCE TO RELATED APPLICATION

The embodiment of the present disclosure is based on and claims a priority of a Chinese patent application No. 202310544843.7, entitled “METHOD AND APPARATUS FOR OPTIMIZING ANDROID CONTAINER DISPLAY SYSTEM, ELECTRONIC DEVICE”, filed on May 15, 2023, the entire contents of which are hereby incorporated herein by reference.

### TECHNICAL FIELD

The present disclosure relates to, but is not limited to, the field of computer technologies, and particularly relates to a method and apparatus for optimizing an Android container display system, an electronic device, a computer-readable storage medium, and a computer program product.

### BACKGROUND

Android systems have been used in various embedded device products, such as mobile phones, tablets and in-vehicle devices because its openness, customizability and widespread use. Since both individual users and cloud computing platform manufacturers may use multi-account login and low-end hardware resources to use high-performance computing applications, if each account has a hardware device or must use high-performance devices, it will cause huge waste of resources. Container virtualization technology can make multiple systems run on one device at the same time, and has the characteristics of transferring high-performance computing to the cloud, thus effectively solving the above problems. According to the characteristics of the Android container, there is an urgent need for a method to optimize rendering of the Android container display system.

### SUMMARY

Embodiments of the present disclosure provide a method and apparatus for optimizing an Android container display system, an electronic device, a computer-readable storage medium, and a computer program product.

An embodiment of the present disclosure provides a method for optimizing an Android container display system. The Android container display system includes: an Android container application layer, an Android system framework layer and a Graphics Processing Unit (GPU) hardware driver layer, a target application is run in the Android container application layer, and the Android system framework layer includes: a Surfaceflinger module and a hardware composer (HWC) program. The method includes the following operations. The HWC program generates a vertical synchronization (vsync) signal, herein the vsync signal includes an application-vertical synchronization (app-vsync) signal; the target application issues a rendering instruction in response to the app-vsync signal, herein the rendering instruction is used to indicate that graphical rendering is performed on a surface in the target application in a hardware rendering manner; the GPU hardware driver layer calls a hardware GPU interfaced with the Android container display system in response to the rendering instruction, to perform graphics rendering, to obtain initial surface rendering data; the Surfaceflinger module outputs the target surface rendering data based on the initial surface rendering data.

Since there is no actual hardware display module in the Android container display system, the embodiment of the present disclosure uses the HWC program to replace the HWC hardware module to generate the vsync signal, thereby effectively reducing the module complexity of the Android container display system and saving the hardware cost of the Android container display system.

It is to be understood that the above general description and the following detailed description are exemplary and explanatory only, and are not limiting of the present disclosure.

### BRIEF DESCRIPTION OF THE DRAWINGS

In order to more clearly explain technical solutions of embodiments of the present disclosure, accompanying drawings necessary for use in the embodiments of the present disclosure or the background art will be described below.

The accompanying drawings herein, which are incorporated into and constitute a part of the specification, illustrate embodiments consistent with the present disclosure, and together with the specification, are used to explain technical solutions of the present disclosure.

FIG. 1 is a schematic diagram of an Android container display system according to an embodiment of the present disclosure.

FIG. 2 is a flowchart of a method for optimizing an Android container display system according to an embodiment of the present disclosure.

FIG. 3 shows a schematic diagram of rendering for an Android container display system according to an embodiment of the present disclosure.

FIG. 4 is a schematic diagram showing a video memory application for an Android container display system according to an embodiment of the present disclosure.

FIG. 5 shows a schematic diagram of a video memory optimization for an Android container display system according to an embodiment of the present disclosure.

FIG. 6 shows a block diagram of a device for optimizing an Android container display system according to an embodiment of the present disclosure.

FIG. 7 shows a block diagram of an electronic device according to an embodiment of the present disclosure.

### DETAILED DESCRIPTION

Various exemplary embodiments, features, and aspects of the present disclosure will be described in detail below with reference to accompanying drawings. Like reference numerals in the drawings indicate functionally identical or similar elements. Although various aspects of embodiments are illustrated in the drawings, the drawings need not be drawn to scale unless otherwise indicated.

A term “exemplary” specifically herein means “used as an example, embodiment, or illustration”. Any embodiment illustrated herein as “exemplary” is not necessarily construed as better than or superior to other embodiments.

A term “and/or” herein is merely used to describe an association relationship of associated objects, indicates that there may be three relationships, e.g., A and/or B, which may mean that there are three situations of A alone, both A and B, or B alone. In addition, A term “at least one” herein means any combination of any one or at least two of a plurality of elements, for example, “including at least one of A, B, C”, may mean including any one or more elements selected from a set of A, B, and C.

In addition, numerous specific details are given in the following detailed description in order to better illustrate the present disclosure. It will be appreciated by those skilled in the art that the present disclosure may also be practiced without certain specific details. In some examples, methods, means, elements, and circuits well known to those skilled in the art are not described in detail in order to highlight the main idea of the present disclosure.

In the related art, optimization at a software level is performed mainly based on application of an Android container display system, but the whole Android container display system cannot be optimized from a hardware level. Moreover, although GPU rendering is used in common optimization methods, but only a standard graphics rendering interface is used. At present, there is no solution on how to optimize the standard graphiccs rendering interface and the Android container display system from a hardware driver layer. Therefore, using the existing native Android container display system to connect containers, especially multiple concurrent Android containers, will increase the complexity of system integration and make software solutions redundant. In the case of large concurrency, there will be a user experience with unsmooth display and poor experience. From a cost perspective, redundant hardware modules in the Android container display system will lead to higher costs.

The present disclosure provides a method for optimizing an Android container display system, which can solve the above problems and realize the optimization of the Android container display system. Hereinafter, the method for optimizing the Android container display system provided by an embodiment of the present disclosure will be described in detail.

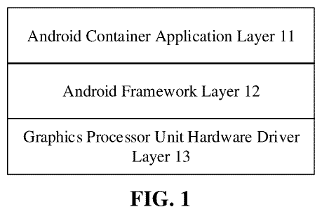

FIG. 1 shows a schematic diagram of an Android container display system according to an embodiment of the present disclosure. As shown in FIG. 1, the Android container display system includes: an Android container application layer 11, an Android system framework layer 12, and a Graphics Processor Unit (GPU) hardware driver layer 13. The top layer is the Android container application layer 11, and user's operations are all in the Android container application layer 11. This layer maintains the native implementation of the Android system, which is convenient to follow the Android system version update, and does not require adaptation. In addition, operation instructions in the Android container are all issued from this layer. The Android system framework layer 12 is located in the middle layer, which plays a connecting role between the preceding and the following. It is connected upward to the Android container application layer 11 and downward to the GPU hardware driver layer 13. The last layer is the GPU hardware driver layer 13, which provides an operation interface for hardware GPU rendering. The Android container application layer 11 and the Android system framework layer 12 are software layers, and the software layer directly faces the platform and users. The GPU hardware driver layer 13 is a driver layer. The driver layer is maintained by a GPU manufacturer and responds to various instructions issued by the software layer.

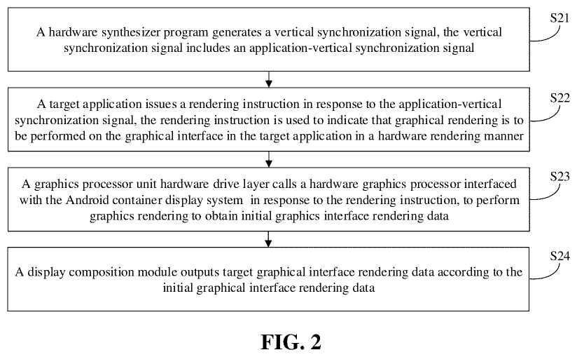

FIG. 2 is a flowchart of a method for optimizing an Android container display system according to an embodiment of the present disclosure. The method may be performed by an electronic device such as a terminal device or a server. The terminal device may be a User Equipment (UE), a mobile device, a user terminal, a terminal, a cellular phone, a cordless phone, a Personal Digital Assistant (PDA), a handheld device, a computing device, a vehicle-mounted device, a wearable device, or the like. The method may be implemented by a processor calling computer-readable instructions stored in a memory. Alternatively, the method may be performed by the server. This method is used to optimize the Android container display system shown in FIG. 1. In the Android container display system, a target application is run in the Android container application layer 11, and the Android system framework layer 12 includes a Surfaceflinger module for display composition and a Hardware Composer (HWC) program. Since there is no actual hardware display device in the Android container display system, the embodiments of the present disclosure adopts the HWC program to replace the HWC hardware module in the related art.

As shown in FIG. 2, the method includes operations S21-S24. In S21, a hardware composer (HWC) program generates a vertical synchronization (vsync) signal. The vsync signal includes an application-vertical synchronization (app-vsync) signal.

In the Android container display system, there is no actual hardware display device. Therefore, the Android container display system does not require a HWC hardware module, and may replace the HWC hardware module with the HWC program. The HWC program is used to generate the app-vsync signal to update data that the target application needs to render.

In S22, the target application issues a rendering instruction in response to the app-vsync signal. The rendering instruction is used to indicate that graphical rendering is performed on a graphical interface (surface) in the target application in a hardware rendering manner.

In one example, the target application, in response to the app-vsync signal, calls the Hardware User Interface (HWUI) module based on the surface in the target application to issue a rendering instruction, to indicate that graphical rendering is performed on data to be rendered in a hardware rendering manner.

In S23, the GPU hardware driver layer 13, in response to the rendering instruction, calls a hardware graphics processor (GPU) interfaced with the Android container display system to perform graphics rendering, to obtain initial graphics interface (surface) rendering data.

The GPU hardware driver layer 13, in response to the rendering instruction, calls the hardware GPU interfaced with the Android container display system using a standard graphics rendering interface, to perform graphics rendering, to obtain the initial surface rendering data.

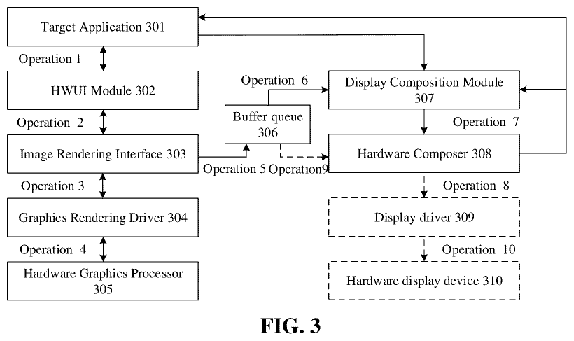

FIG. 3 shows a schematic diagram of rendering of the Android container display system according to an embodiment of the present disclosure. As shown in FIG. 3, in operation 1, a target application 301 calls a HWUI module 302. In operations 2-4, the HWUI module 302 updates various state information corresponding to graphics rendering to a hardware GPU 405 through a graphics rendering driver 304 by using a standard graphics rendering interface 303, so that graphics rendering operations are performed in a hardware GPU 305, and initial surface rendering data corresponding to the target application 301 is returned. In the Android system, standard graphics rendering interfaces include: opengles and vulkan, and the standard graphics rendering interfaces may include other interfaces according to an actual situation, which is not specifically limited in this application.

In operations 5-6 as shown in FIG. 3, the initial surface rendering data is transmitted to a Surfaceflinger module 307 through a Buffer Queue 306. In the Android system of the related art, there are operations 7-10 as shown in FIG. 3: after receiving the initial surface rendering data, the display composition module 307 queries whether the hardware GPU 305 is to be used for composition; and if the hardware GPU 305 is to be used for composition, the composed data is transferred to the HWC 308, which requires the HWC 308 to receive the data through the Buffer Queue, as shown in operation 9 of FIG. 3; further, the composed data is sent to the hardware display 310 through the display driver 309 to perform hardware display.

However, in the Android container display system, since there is no corresponding hardware display device. That is, in the Android container display system, there is no the display driver 309 and the hardware display device 310 indicated in the dashed boxes shown in FIG. 3. Therefore, the Android container display system does not require the HWC hardware module, and the HWC program may be used to replace the HWC hardware module. That is, in the related art, the HWC shown in FIG. 3 is an HWC hardware module. In the embodiments of the present disclosure, the HWC shown in FIG. 3 is an HWC program. The vsync signal is generated using the HWC program.

Since there is no display driver and hardware display device, and there is no need to perform the downward transmission of the synthesized display data in operations 8-10, the application and use of the Buffer Queue shown in operation 9 are further reduced.

In S24, the Surfaceflinger module outputs target graphical interface (surface) rendering data according to the initial graphical interface (surface) rendering data.

Hereinafter, a specific process of how the Surfaceflinger module outputs the target surface rendering data based on the initial surface rendering data will be described in detail in conjunction with possible implementations of the embodiments of the present disclosure.

In the embodiments of the present disclosure, since there is no actual hardware display device in the Android container display system, the HWC program is used to replace the HWC hardware module to generate the vsync signal, thereby effectively reducing the module complexity of the Android container display system and saving the hardware cost of the Android container display system.

In one possible implementation, the vsync signal comprises: a sf-vsync signal. The Surfaceflinger module outputs the target surface rendering data after performing data processing on the initial surface rendering data in response to the sf-vsync signal.

The sf-vsync signal is used to instruct the Surfaceflinger module to perform data processing on the initial surface rendering data to obtain the target surface rendering data to update the screen display information.

In one possible implementation, the HWC program generates the vsync signal in a timer trigger manner.

The HWC program generates the app-vsync signal and the sf-vsync signal in a timer trigger manner. The timing trigger interval for the app-vsync signal and the sf-vsync signal may be configured according to the actual display requirement of the Android container display system, which is not specifically limited in the present disclosure. As shown in FIG. 3, the HWC generates an app-vsync signal and a graphical interface-vsync signal.

In a possible implementation, the Surfaceflinger module issues a request regarding whether to perform a composition operation to the HWC program, and the request regarding whether to perform a composition operation is used to determine whether to call the hardware GPU for a composition operation. After receiving an instruction to perform the composition operation returned by the HWC program, the Surfaceflinger module calls the hardware GPU to compose the initial surface rendering data in response to the sf-vsync signal, to obtain and output the target surface rendering data.

The Surfaceflinger module issues, to the HWC program, a request regarding whether to perform the composition operation, which is used to determine whether to call the hardware GPU for the composition operation.

In an example, the HWC program may indicate that the hardware GPU is called to perform the composition operation (an instruction to perform the composition operation) by returning a first flag bit. For example, in case that the HWC program returns the first flag bit of 0, it indicates that the hardware GPU is called to perform the composition operation. The first flag bit may take other forms in addition to a form of being 0, and the present disclosure does not specifically limit this. In addition to that the HWC program may indicate that the hardware GPU is called to perform the composition operation by returning the first flag bit, the HWC program may also indicate that the hardware GPU is called to perform the composition operation by using other implementations, which is not specifically limited in the present disclosure.

When it is necessary to call the hardware GPU to perform the composition operation, the Surfaceflinger module calls the hardware GPU to perform the composition operation on the initial surface rendering data in response to the sf-vsync signal, to obtain and output the target surface rendering data.

In one possible implementation, in a full-screen rendering scene, the Surfaceflinger module directly outputs the initial surface rendering data as the target surface rendering data.

The full-screen rendering scene may be a game scene running in an Android container, or may be other scenes requiring full-screen display, which is not specifically limited in the present disclosure.

In the full-screen rendering scene, there is no need to render and update the desktop status bar, navigation bar, desktop background, etc. However, in the related art, even in a full-screen rendering scene, composition operations are also need to be performed by the Surfaceflinger module to output them. Redundant composition operations will make the processing flow longer and the data output efficiency lower. In the case of large Android containers starting simultaneously, it will cause the displayed screen to be stuck and the smoothness to be reduced.

Therefore, in the embodiments of the present disclosure, in order to optimize the Android container display system in the full-screen rendering scene, in the full-screen rendering scene, the Surfaceflinger module directly outputs the initial surface rendering data as the target surface rendering data without performing any composition operation, thereby improving the data output efficiency in the full-screen rendering scene, and improving the smoothness of the displayed screen in the case of concurrent startup of large Android containers. At this time, the refresh rate of the displayed screen is updated only via the app-vsync signal, and it is not required to perform the composition operation via the sf-vsync signal.

In a possible implementation, the Surfaceflinger module issues, to the HWC program, a request regarding whether to perform a composition operation, and the request regarding whether to perform the composition operation is used to determine whether to call the hardware GPU for the composition operation. The Surfaceflinger module directly outputs the initial surface rendering data as the target surface rendering data after receiving the instruction not to perform the composition operation returned by the HWC program.

The Surfaceflinger module issues, to the HWC program, a request regarding whether to perform the composition operation request, which is used to determine whether to call the hardware GPU for the composition operation.

In an example, the HWC program may indicate that the hardware GPU does not need to be called for the composition operation (an instruction not to perform the composition operation) by returning a second flag bit. For example, in case that the HWC program returns the second flag bit of 1, it indicates that the hardware GPU does not need to be called for the composition operation. The second flag bit may take other forms in addition to the form of being 1, and this is not specifically limited in the present disclosure. In addition to that the HWC program may indicate that the hardware GPU does not need to be called for the composition operation by returning the second flag bit, the HWC program may indicate that the hardware GPU does not need to be called for the composition operation by using other implementations, which is not specifically limited in the present disclosure.

The Surfaceflinger module directly outputs the initial surface rendering data as the target surface rendering data without calling the hardware GPU for the composition operation.

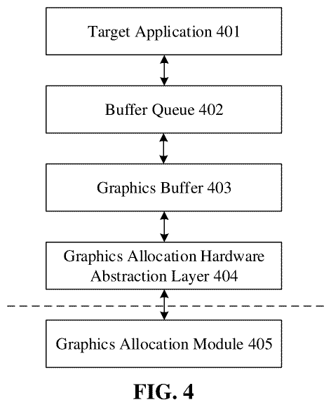

FIG. 4 is a schematic diagram showing a video memory application for the Android container display system according to an embodiment of the present disclosure. As shown in FIG. 4, the target application 401 corresponding to the Android container display system applies for a video memory based on a buffer Queue 402, and the buffer Queue uses a Graphics buffer (Graphicbuffer) 403 to describe a Graphic buffer for cross-process transfer. The underlying implementation of Graphicbuffer is completed by the GPU manufacturer. The focus is to connect the graphics allocation (Gralloc) module 405 in the GPU driver layer through the graphics allocation (Gralloc) Hardware Abstraction Layer (HAL) 404. The Gralloc module is used to apply for and manage the video memory.

In one possible implementation, the GPU hardware driver layer includes: a Gralloclock module and a direct memory access (DMA) module. In a cast that the Android container display system accesses the video memory data in the hardware GPU based on the Gralloclock module, the DMA module is used to transmit the video memory data to the system memory corresponding to the Android container display system, and the Android container display system reads the video memory data from the system memory.

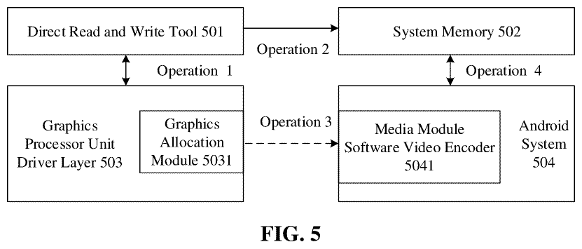

FIG. 5 shows a schematic diagram of a video memory optimization for an Android container display system according to an embodiment of the present disclosure. As shown in FIG. 5, in case that the Android container display system accesses the video memory data in the hardware GPU based on the graphics allocation (Grallo) module 5031, in operation 1, the Android container display system issues a video memory read instruction to the GPU driver layer 503 based on the direct read/write tool (devmem) 501. In the related art, operation 3 is adopted to map the video memory data in the hardware GPU to the Android system 504 by means of a memory-mapped file mmap. For example, as shown in FIG. 3, the video memory data in the hardware GPU is mapped to a software video encoder (Soft Video Encoder) 5041 in the media module of the Android system 504 by means of a memory-mapped file mmap. However, reading video memory data by means of the memory-mapped file mmap will lead to a high occupancy rate of the Central Processing Unit (CPU) corresponding to the Android container display system, and a slow data reading speed, resulting in an unsmooth displayed screen corresponding to the Android system 504. The displayed screen is stuck and not smooth. Herein, an Android container and an application in the container are run in the CPU, and a Surfaceflinger module, an HWC program, and the like in the Android system 504 are interfaced with the CPU. The Gralloclock module in the GPU driver layer realizes the application and release of video memory in Android system.

In the embodiments of the present disclosure, operation 3 is cancelled, and operation 2 is adopted in which the DMA module is used to transmit the video memory data to the system memory 502 corresponding to the Android container display system. In this way, operation 4 can be executed, in which the CPU corresponding to the Android container display system directly reads the video memory data from the system memory 502, thereby effectively improving the reading rate of the video memory data. As shown in FIG. 3, the DMA module is used to transmit the video memory data to the system memory 502 corresponding to the Android container display system, and the Soft Video Encoder in the media module of the Android container display system can directly read the video memory data from the system memory 502. The embodiments of the present disclosure provide a fast and efficient video memory usage mode at the hardware driver level, and optimize the Android container display system at the hardware driver level.

In one possible implementation, the host operating system performing the optimization method of the Android container display system is an operating system based on a Linux distribution.

Since the Android system 504 is an operating system based on a Linux distribution, the host operating system that executes the methods for optimizing the Android container display system is also an operating system based on a Linux distribution. The Linux distribution may be Debian, Fedora, SUSE, Gentoo, Ubuntu, etc., or may be other Linux distributions, which are not specifically limited in this application.

It may be appreciated that each of the above-described method embodiments mentioned in the present disclosure can be combined with each other to form a combined embodiment without violating the principle and logic. It will be understood by those skilled in the art that in the above-described methods of the detailed embodiments, the specific order of execution of the operations should be determined according to their functions and possibly inherent logic.

In addition, the present disclosure also provides an apparatus for optimizing an Android container display system, an electronic device, a computer-readable storage medium, and a program, all of which can be used to implement any one of the methods for optimizing the Android container display system provided in the present disclosure. For corresponding technical solutions and descriptions, reference should be made to the corresponding description in the methods section.

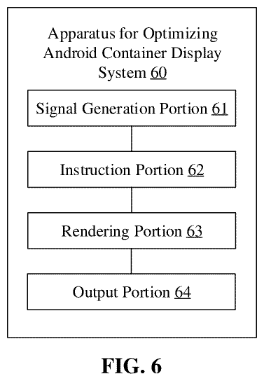

FIG. 6 shows a block diagram of an apparatus for optimizing an Android container display system according to an embodiment of the present disclosure. The Android container display system includes: an Android container application layer 11, an Android system framework layer 12 and a GPU hardware driver layer 13. A target application is run in the Android container application layer 11. The Android system framework layer 12 includes: a Surfaceflinger module and a HWC program. As shown in FIG. 6, the apparatus 60 for optimizing the Android container display system includes: a signal generation portion 61, an instruction portion 62, a rendering portion 63 and an output portion 64. The signal generation portion 61 is configured to control the HWC program to generate a vsync signal, herein the vsync signal includes: an app-vsync signal.

The instruction portion 62 is configured to control the target application to issue a rendering instruction in response to the app-vsync signal. The rendering instruction is used to indicate that graphical rendering is performed on a surface in the target application in a hardware rendering manner.

The rendering portion 63 is configured to control the GPU hardware driver layer to call the hardware GPU which is interfaced with the Android container display system in response to the rendering instruction, to perform graphics rendering, to obtain initial surface rendering data.

The output portion 64 is configured to control the Surfaceflinger module to output target surface rendering data according to the initial surface rendering data.

In one possible implementation, the vsync signal further includes: an sf-vsync signal. The output portion 64 is further configured to control the Surfaceflinger module to output the target surface rendering data after performing data processing on the initial surface rendering data in response to the sf-vsync signal.

In one possible implementation, the output portion 64 is configured to: control the Surfaceflinger module to issue a request regarding whether to perform a composition operation to the HWC program. The request regarding whether to perform the composition operation is used to determine whether to call the hardware GPU for the composition operation; and
control the Surfaceflinger module, after receiving an instruction to perform the composition operation returned by the HWC program, to call the hardware GPU to perform the composition operation on the initial surface rendering data in response to the sf-vsync signal, to obtain and output the target surface rendering data.

In one possible implementation, in a full-screen rendering scene, the output portion 64 is configured to control the Surfaceflinger module to directly output the initial surface rendering data as the target surface rendering data.

In one possible implementation, the output portion 64 is configured to: control the Surfaceflinger module to issue a request regarding whether to perform a composition operation to the HWC program, and the request regarding whether to perform the composition operation is used to determine whether to call the hardware GPU for the composition operation; and
control the Surfaceflinger module, after receiving an instruction not to perform the composition operation returned by the HWC program, to directly output the initial surface rendering data as the target surface rendering data.

In one possible implementation, the signal generation portion 61 is configured to control the HWC program to generate a vsync signal in a timer trigger manner.

In one possible implementation, the GPU hardware driver layer includes: a Gralloclock module and a DMA module. The apparatus 60 for optimizing the Android container display system further includes: a transmission portion and a reading portion.

The transmission portion is configured to, in case that the Android container display system accesses video memory data in the hardware GPU based on the Gralloclock module, transmit the video memory data to a system memory corresponding to the Android container display system using the DMA module.

The reading portion is configured to control the Android container display system to the read video memory data from the system memory.

In the embodiments of the present disclosure and other embodiments, the “portion” may be a part of a circuit, a part of a processor, a part of a program or software, or the like, or, it may be a unit, a module or a non-modular one.

In one possible implementation, a host operating system corresponding to the apparatus for optimizing the Android container display system is an operating system based on a Linux distribution.

The method has specific technical correlation with the internal structure of the computer system, and can solve the technical problems of how to improve the hardware operation efficiency or the execution effect (including reducing the data storage amount, reducing the data transmission amount, improving the hardware processing speed, etc.), so as to obtain the technical effect of improving the internal performance of the computer system in accordance with the natural law.

In some embodiments, the functions or modules included in the apparatus provided by the embodiments of the present disclosure may be used to perform the methods described in the above method embodiments, and the specific implementation thereof may refer to the description of the above method embodiments.

An embodiment of the present disclosure also provide a computer-readable storage medium storing computer program instructions thereon, and the computer program instructions, when executed by a processor, implement the above methods. The computer-readable storage medium may be a volatile or non-volatile computer-readable storage medium.

An embodiment of the present disclosure also provides an electronic device, which includes: a processor; and a memory for storing processor-executable instructions. The processor is configured to call the instructions stored in the memory to perform the methods described above.

An embodiment of the present disclosure also provide a computer program product including a computer-readable code or a non-volatile computer-readable storage medium carrying the computer-readable code, and when the computer-readable code is run in a processor of the electronic device, the processor in the electronic device executes the above-described method.

The electronic device may be provided as a terminal, server, or other form of device.

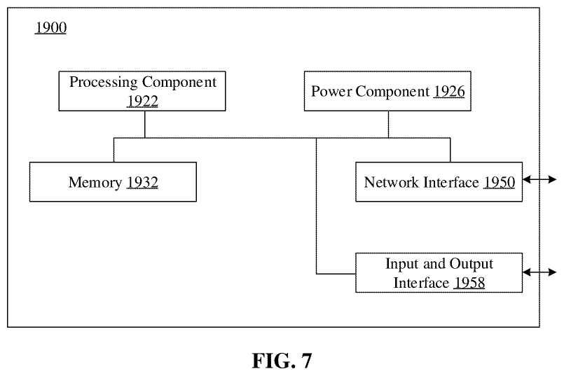

FIG. 7 shows a block diagram of an electronic device according to an embodiment of the present disclosure. Referring to FIG. 7, the electronic device 1900 may be provided as a server or terminal device. Referring to FIG. 7, the electronic device 1900 includes a processing component 1922 that further includes one or more processors, and a memory resource represented by a memory 1932 for storing instructions, such as an application, executable by the processing component 1922. The application stored in the memory 1932 may include one or more modules each corresponding to a set of instructions. Further, the processing component 1922 is configured to execute instructions to perform the method described above.

The electronic device 1900 may also include a power component 1926 configured to perform power management of the electronic device 1900, a wired or wireless network interface 1950 configured to connect the electronic device 1900 to a network, and an input/output interface 1958. The electronic device 1900 may operate based on an operating system stored in the memory 1932, such as a Microsoft server operating system (Windows Server™), a graphical user interface based operating system (Mac OS X™) introduced by Apple, a multi-user, multi-process computer operating system (Unix™), a free and open-source Unix-like operating system (Linux™), an open-source Unix-like operating system (FreeBSD™) or similar.

In an exemplary embodiment, a non-volatile computer-readable storage medium, such as a memory 1932 including computer program instructions executable by the processing component 1922 of the electronic device 1900 to perform the method described above, is also provided.

The present disclosure may be a system, method, and/or computer program product. The computer program product may include a computer-readable storage medium on which computer-readable program instructions are loaded for causing a processor to implement various aspects of the present disclosure.

A computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination of the foregoing. More specific examples (non-exhaustive list) of computer-readable storage media include a portable computer disk, a hard disk, a Random Access Memory (RAM), a Read Only Memory (ROM), an Erasable Programmable Read-Only Memory (EPROM or flash memory), a static Random Access Memory (SRAM), a portable Compact Disc Read-Only Memory (CD-ROM), a Digital Video Disc (DVD), a memory stick, a floppy disk, a mechanical encoding device, such as a punch card or an in-groove raised structure having instructions stored thereon, and any suitable combination thereof. Computer-readable storage media as used herein are not to be construed as transient signals per se, such as radio waves or other freely propagating electromagnetic waves, electromagnetic waves propagating through waveguides or other transmission media (e.g., light pulses through fiber optic cables), or electrical signals transmitted through electrical wires.

The computer-readable program instructions described herein may be downloaded from a computer-readable storage medium to various computing/processing devices, or to an external computer or external storage device over a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or network interface in each computing/processing device receives computer-readable program instructions from a network and forwards the computer-readable program instructions for storage in a computer-readable storage medium in the respective computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including object-oriented programming languages, such as Smalltalk, C++, etc., and conventional procedural programming languages, such as the “C” language or similar programming languages. The computer-readable program instructions may be executed entirely on the user's computer, partially on the user's computer, as a standalone software package, partially on the user's computer and partially on a remote computer, or entirely on a remote computer or server. In cases involving a remote computer, the remote computer may be connected to the user computer through any kind of network, including a Local Area Network (LAN) or a Wide Area Network (WAN), or may be connected to an external computer (e.g., using an Internet service provider to connect over the Internet). In some embodiments, an electronic circuit (such as a programmable logic circuit, a Field Programmable Gate Array (FPGA), or a Programmable Logic Array (PLA)) is customized by utilizing state information of computer-readable program instructions, the electronic circuit can execute the computer-readable program instructions to implement various aspects of the present disclosure.

Various aspects of the present disclosure are described herein with reference to flowcharts and/or block diagrams of methods, apparatus (systems), and computer program products according to embodiments of the present disclosure. It should be understood that each block of the flowchart and/or block diagrams, and combinations of blocks in the flowchart and/or block diagrams, may be implemented by computer-readable program instructions.

These computer-readable program instructions may be provided to a processor of a general-purpose computer, a special-purpose computer, or other programmable data processing apparatus, thereby producing a machine such that, when executed by the processor of the computer or other programmable data processing apparatus, the instructions produce means for implementing the functions/acts specified in one or more blocks in the flowchart and/or block diagram. Such computer-readable program instructions may also be stored in a computer-readable storage medium that cause the computer, programmable data processing apparatus, and/or other apparatus to operate in a particular manner, such that the computer-readable medium storing the instructions includes an article of manufacture including instructions that implement various aspects of the functions/acts specified in one or more blocks in the flowchart and/or block diagram.

Computer-readable program instructions may also be loaded onto a computer, other programmable data processing apparatus, or other apparatus such that a series of operational operations are performed on the computer, other programmable data processing apparatus, or other apparatus to produce a computer-implemented process such that the instructions executed on the computer, other programmable data processing apparatus, or other apparatus implement the functions/acts specified in one or more blocks in the flowchart and/or block diagram.

The flowcharts and block diagrams in the drawings illustrate the architecture, functionality, and operation of possible implementations of systems, methods, and computer program products in accordance with various embodiments of the present disclosure. In this regard, each block in the flowchart or block diagram may represent a module, program segment, or portion of instructions containing one or more executable instructions for implementing a specified logical function. In some alternative implementations, the functions noted in the blocks may also occur in a different order than that noted in the figures. For example, two consecutive blocks may actually be executed substantially in parallel, and they may sometimes be executed in reverse order, depending on the function involved. It is also noted that each block in the block diagrams and/or flowchart diagrams, and combinations of blocks in the block diagrams and/or flowchart diagrams, may be implemented with a dedicated hardware-based system that performs the specified functions or acts, or may be implemented with a combination of dedicated hardware and computer instructions.

The computer program product may be implemented in particular by means of hardware, software, or a combination thereof. In an alternative embodiment, the computer program product is embodied as a computer storage medium, and in another alternative embodiment, the computer program product is embodied as a software product, such as a Software Development Kit (SDK) or the like.

The above description of the various embodiments tends to emphasize the differences between the various embodiments, and the same or similar parts may be referred to each other.

Those skilled in the art will understand that in the above-described method of the detailed embodiment, the order in which the operations are written does not mean a strict order of execution and constitutes any limitation on the implementation process, and the specific order of execution of the operations should be determined by its function and possible internal logic.

If the technical solution of this application involves personal information, the product applying the technical solution of this application has clearly informed the personal information processing rules and obtained the individual's independent consent before processing the personal information. If the technical solution of this application involves sensitive personal information, the product applying the technical solution of this application has obtained the individual's consent, and meets the requirement of “express consent” at the same time before processing the sensitive personal information. For example, at a personal information collection device such as a camera, a clear and obvious sign is set to inform that it has entered the personal information collection scope, and the personal information will be collected. If an individual voluntarily enters the collection scope, it is deemed that he has agreed to collect his personal information. Or on the personal information processing device, when obvious identification/information is used to inform the personal information processing rules, personal authorization is obtained through pop-up information or asking individuals to upload their personal information by themselves. The personal information processing rules may include information such as a personal information processor, a personal information processing purpose, a processing method, and a type of personal information to be processed.

Although various embodiments of the present disclosure have been described above, the above description is exemplary, not exhaustive, and is not limited to the disclosed embodiments. Many modifications and alterations will be apparent to those of ordinary skill in the art without departing from the scope and spirit of the illustrated embodiments. The choice of terminology used herein is intended to better explain the principles, practical applications, or improvements to techniques in the market of the various embodiments, or to enable others of ordinary skill in the art to understand the various embodiments disclosed herein.

### INDUSTRIAL APPLICABILITY

Embodiments of the present application relate to the technical field of computers, and provide a method and apparatus for optimizing an Android container display system, an electronic device, a computer-readable storage medium, and a computer program product. The method for optimizing the Android container display system includes: a HWC program generates a vsync signal, herein the vsync signal includes an app-vsync signal; a target application issues a rendering instruction in response to the app-vsync signal, herein the rendering instruction is used to indicate that graphical rendering is performed on a surface in the target application in a hardware rendering manner; a GPU hardware driver layer calls a hardware GPU interfaced with the Android container display system in response to the rendering instruction, to perform graphics rendering, to obtain initial surface rendering data; the Surfaceflinger module outputs the target surface rendering data based on the initial surface rendering data. The embodiments of the present disclosure can effectively reduce the module complexity of the Android container display system and save the hardware cost.

1. A method for optimizing an Android container display system, applied to an electronic device, the Android container display system comprising: an Android container application layer, an Android system framework layer and a Graphics Processing Unit (GPU) hardware driver layer, a target application being run in the Android container application layer, and the Android system framework layer comprising: a Surfaceflinger module and a hardware composer (HWC) program;
the method comprising:
generating, by the HWC program, a vertical synchronization (vsync) signal, wherein the vsync signal comprises an application-vertical synchronization (app-vsync) signal;
issuing, by the target application in response to the app-vsync signal, a rendering instruction, wherein the rendering instruction is used to indicate that graphical rendering is performed on a surface, which is a graphical interface, in the target application in a hardware rendering manner;
calling, by the GPU hardware driver layer in response to the rendering instruction, a hardware GPU which is interfaced with the Android container display system, to perform graphics rendering, to obtain initial surface rendering data; and
outputting, by the Surfaceflinger module, target surface rendering data according to the initial surface rendering data.

2. The method of claim 1, wherein the vsync signal further comprises: a graphical interface-vertical synchronization (sf-vsync) signal, and
the Surfaceflinger module outputs the target surface rendering data after performing data processing on the initial surface rendering data in response to the sf-vsync signal.

3. The method of claim 2, wherein the Surfaceflinger module issues a request regarding whether to perform a composition operation to the HWC program, wherein the request regarding whether to perform the composition operation is used to determine whether to call the hardware GPU for the composition operation; and
after receiving an instruction to perform the composition operation returned by the HWC program, the Surfaceflinger module calls, in response to the sf-vsync signal, the hardware GPU to perform the composition operation on the initial surface rendering data, to obtain and output the target surface rendering data.

4. The method of claim 1, wherein in a full-screen rendering scene, the Surfaceflinger module directly outputs the initial surface rendering data as the target surface rendering data.

5. The method of claim 4, wherein the Surfaceflinger module issues a request regarding whether to perform a composition operation to the HWC program, and the request regarding whether to perform the composition operation is used to determine whether to call the hardware GPU for the composition operation;
after receiving an instruction not to perform the composition operation returned by the HWC program, the Surfaceflinger module directly outputs the initial surface rendering data as the target surface rendering data.

6. The method of claim 1, wherein the HWC program generates the vsync signal in a timer trigger manner.

7. The method of claim 1, wherein the GPU hardware driver layer comprises: a graphics allocation (Gralloclock) module and a direct memory access (DMA) module;
in case that the Android container display system accesses video memory data in the hardware GPU based on the Gralloclock module, the Android container display system transmits the video memory data to a system memory corresponding to the Android container display system using the DMA module;
the Android container display system reads the video memory data from the system memory.

8. The method of claim 1, wherein a host operating system executing the method of optimizing the Android container display system is an operating system based on a Linux distribution.

9. An electronic device for optimizing an Android container display system, the Android container display system comprising: an Android container application layer, an Android system framework layer, and a Graphics Processing Unit (GPU) hardware driver layer, a target application being run in the Android container application layer, and the Android system framework layer comprising: a Surfaceflinger module and a hardware composer (HWC) program;
the electronic device comprising:
a processor; and
a memory for storing processor executable instructions;
wherein the processor is configured to call the instructions stored in the memory to:
control the HWC program to generate a vertical synchronization (vsync) signal, wherein the vsync signal comprises an application-vertical synchronization (app-vsync) signal;
control the target application to issue a rendering instruction in response to the app-vsync signal, wherein the rendering instruction is used to indicate that graphical rendering is performed on a surface in the target application in a hardware rendering manner;
control the GPU hardware driver layer to call a hardware GPU which is interfaced with the Android container display system in response to the rendering instruction, to perform graphics rendering, to obtain initial surface rendering data; and
control the Surfaceflinger module to output target surface rendering data according to the initial surface rendering data.

10. The electronic device of claim 9, wherein the vsync signal further comprises: a graphical interface-vertical synchronization (sf-vsync) signal, and the processor is further configured to call the instructions stored in the memory to control the Surfaceflinger module to output the target surface rendering data after performing data processing on the initial surface rendering data in response to the sf-vsync signal.

11. The electronic device of claim 10, wherein the processor is further configured to call the instructions stored in the memory to:
control the Surfaceflinger module to issue a request regarding whether to perform a composition operation to the HWC program, wherein the request regarding whether to perform the composition operation is used to determine whether to call the hardware GPU for the composition operation; and
control the Surfaceflinger module, after receiving an instruction to perform the composition operation returned by the HWC program, to call, in response to the sf-vsync signal, the hardware GPU to perform the composition operation on the initial surface rendering data, to obtain and output the target surface rendering data.

12. The electronic device of claim 9, wherein in a full-screen rendering scene, the processor is further configured to call the instructions stored in the memory to:
control the Surfaceflinger module to directly output the initial surface rendering data as the target surface rendering data.

13. The electronic device of claim 12, wherein the processor is further configured to call the instructions stored in the memory to:
control the Surfaceflinger module to issue a request regarding whether to perform a composition operation to the HWC program, and the request regarding whether to perform the composition operation is used to determine whether to call the hardware GPU for the composition operation; and
control the Surfaceflinger module, after receiving an instruction not to perform the composition operation returned by the HWC program, to directly output the initial surface rendering data as the target surface rendering data.

14. The electronic device of claim 9, wherein the processor is further configured to call the instructions stored in the memory to:
control the HWC program to generate the vsync signal in a timer trigger manner.

15. The electronic device of claim 9, wherein the GPU hardware driver layer comprises: a graphics allocation (Gralloclock) module and a direct memory access (DMA) module;
the processor is further configured to call the instructions stored in the memory to:
in case that the Android container display system accesses video memory data in the hardware GPU based on the Gralloclock module, control the DMA module to transmit the video memory data to a system memory corresponding to the Android container display system using the DMA module; and
control the Android container display system to read the video memory data from the system memory.

16. The electronic device of claim 9, wherein a host operating system corresponding to the electronic device for optimizing the Android container display system is an operating system based on a Linux distribution.

17. (canceled)

18. A non-transitory computer-readable storage medium having stored thereon computer program instructions that, when executed by a processor, implement a method for optimizing an Android container display system, the Android container display system comprising: an Android container application layer, an Android system framework layer, and a Graphics Processing Unit (GPU) hardware driver layer, a target application being run in the Android container application layer, and the Android system framework layer comprising: a Surfaceflinger module for display composition and a hardware composer (HWC) program:
the method comprising:
generating, by the HWC program, a vertical synchronization (vsync) signal, wherein the vsync signal comprises an application-vertical synchronization (app-vsync) signal;
issuing, by the target application in response to the app-vsync signal, a rendering instruction, wherein the rendering instruction is used to indicate that graphical rendering is performed on a graphical interface (surface) in the target application in a hardware rendering manner;
calling, by the GPU hardware driver layer in response to the rendering instruction, a hardware GPU which is interfaced with the Android container display system, to perform graphics rendering, to obtain initial surface rendering data; and
outputting, by the Surfaceflinger module, target surface rendering data according to the initial surface rendering data.

19. The non-transitory computer-readable storage medium of claim 18, wherein the vsync signal further comprises: a graphical interface-vertical synchronization (sf-vsync) signal, and
the Surfaceflinger module outputs the target surface rendering data after performing data processing on the initial surface rendering data in response to the sf-vsync signal.

20. The non-transitory computer-readable storage medium of claim 19, wherein the Surfaceflinger module issues a request regarding whether to perform a composition operation to the HWC program, wherein the request regarding whether to perform the composition operation is used to determine whether to call the hardware GPU for the composition operation; and
after receiving an instruction to perform the composition operation returned by the HWC program, the Surfaceflinger module calls, in response to the sf-vsync signal, the hardware GPU to perform the composition operation on the initial surface rendering data, to obtain and output the target surface rendering data.
